(19) United States
(12) Patent Application Publication
(10) Pub. No.: US 2020/0063665 A1
(43) Pub. Date: Feb. 27, 2020

(54) AERO-ENGINE FULL FLIGHT ENVELOPE MODEL ADAPTIVE MODIFICATION METHOD BASED ON DEEP LEARNING ALGORITHM

(71) Applicant: Dalian University of Technology, Dalian City (CN)

(72) Inventors: Yanhua MA, Dalian City (CN); Xian DU, Dalian City (CN); Ximing SUN, Dalian City (CN)

(21) Appl. No.: 16/462,504

(22) PCT Filed: Jan. 25, 2018
(86) PCT No.: PCT/CN2018/074084

§ 371 Date: May 20, 2019

(51) Int. Cl. F02D 28/00; G07C 5/00; G06N 3/08

(52) U.S. Cl. CPC F02D 28/00; G06N 3/08; G07C 5/004

(57) ABSTRACT

An aero-engine full flight envelope model adaptive modification method based on a deep learning algorithm. A dynamic parallel compensator based on a recursive neural network is adopted to compensate the error of the original nonlinear model within the full flight envelope under the condition without aero-engine performance deterioration. A modifier based on a genetic algorithm is also adopted to conduct adaptive adjustment on correction coefficients of health parameters to be modified in the original nonlinear component-level model. The health parameters to be modified are determined by a multi-attribute decision algorithm based on integrated evaluation. The sum of the modified nonlinear component-level model output and the compensator output is consistent with the aero-engine operation test output data. This provides powerful support for the design of aero-engine control systems and fault diagnosis systems.

### TECHNICAL FIELD

The present invention relates to an aero-engine full flight envelope model adaptive modification method based on a deep learning algorithm, in particular to a model modification technology for realizing exact approximation of model output to test data within the aero-engine full flight envelope operating range, belonging to the technical field of aero-engine modeling and simulation.

### BACKGROUND

The present invention replies on the background of a nonlinear component-level mathematical model of a certain type of low bypass ratio turbofan engine. Frequently-used aero-engine component-level models at present are established according to nominal characteristics of aero-engines without consideration of performance difference among different aero-engines. Furthermore, multiple components of an engine work together. Even if the model characteristics of components are very precise, engine performance parameters calculated from the nominal nonlinear component-level model by simulation have relatively large deviation from actual performance parameters due to interference caused by factors such as interaction between components, manufacture and assembly errors, service wear and performance deterioration. The effectiveness and the accuracy of the design and simulation verification of the aero-engine control systems and fault diagnosis systems are closely related to the nonlinear models of aero-engines. Therefore, the adaptive modification of early established aero-engine component-level nonlinear models according to the test data has great engineering significance.

The existing domestic and foreign aero-engine model modification technologies mainly focus on the component characteristic modification based on a steady state operation point, i.e., for a given steady state operation point, various solving methods are adopted to adjust modification parameters, and such modification process is the optimization process of steady state model parameters to a certain degree. For the transient state of an aero-engine, the general method at present is still based on the steady state operation point model, and the interpolation algorithm is adopted to approximate the transient state process. The dynamic response error of the model is large due to a small number of feature steady state operation points and large interpolation errors. Therefore, the precision problem of key output parameters of the transient state process within the full flight envelope is difficult to solve by the above-mentioned model modification method. Further, the number of health parameters involved in the aero-engine model is much more than that of key measurable parameters of the aero-engine. In actual engineering applications, only the health parameters equivalent to the number of key measurable parameters are often selected for adaptive adjustment. The existing health parameter selection method is mostly the modification parameter perturbation method, i.e., a step signal is generated for health parameter correction coefficients, the variation of the key output parameters of the aero-engine is measured, and the health parameters to be modified are selected sequentially according to changes in the amplitude. However, because the variation of the key output parameters does not change linearly with the health parameter correction coefficients, the selection of an inappropriate step signal amplitude will affect the selection of the health parameters to be modified, thereby reducing the accuracy of the modified model. Finally, the above-mentioned method directly modifies the original nonlinear model without considering the modeling error between the original nonlinear model and the actual operation condition, which reduces the precision of the model and the reliability of the modification parameters.

In conclusion, to overcome the defects of the existing aero-engine full flight envelope model modification technology for control, i.e., in the above-mentioned three cases of modifying the transient state based on the steady state model parameters, selecting the health parameters to be modified based on the step signal response and not considering the error of the original component-level model, the present invention provides an aero-engine full flight envelope model adaptive modification method for control based on a deep learning algorithm. This method directly modifies the model within the aero-engine full flight envelope, adopts a more reasonable multi-attribute decision algorithm based on integrated evaluation to realize the selection of health parameters and compensates the original engine modeling error in order to make the modified model more precise. Meanwhile, the method can be extended to the modeling and modification of other types of turbine engines and marine gas turbine engines through appropriate adjustment, and has wider universality.

### SUMMARY

Aiming at the problem that the high-precision modification of the aero-engine full flight envelope is difficult to realize in the prior art, the present invention provides an aero-engine full flight envelope model adaptive modification method based on a deep learning algorithm.

The technical solution of the present invention is as follows:

An aero-engine full flight envelope model adaptive modification method based on a deep learning algorithm, comprising the following steps:

S1. generating training data and test data for establishing a dynamic parallel compensator based on a recursive neural network algorithm according to the collected test data of the condition without performance deterioration in the aero-engine full flight envelope operation test data;

S2. building a dynamic parallel compensator based on a recursive neural network algorithm by using the generated training data and test data of the dynamic parallel compensator;

S3. determining health parameters to be modified in the aero-engine original nonlinear component-level model by a multi-attribute decision algorithm based on integrated evaluation according to the test data of the deterioration condition of the aero-engine full flight envelope;

S4. building a modifier based on a genetic algorithm, and setting the number of modifications to 20≥Q>0;

S5. conducting adaptive modification on the correction coefficients of the health parameters to be modified in the original nonlinear component-level model;

S6. calculating the sum of the modified nonlinear component-level model output and the dynamic parallel compensator output under a given input signal, and then subtracting the corresponding output data in the aero-engine full flight envelope operation test data under the given condition; if the difference e is not greater than the error threshold ε, 0.05≥ε>0 or the number of modifications Q is reached, entering S7; otherwise, returning to S5;

S7. saving the modified correction coefficients of the health parameters to be modified.

The steps of generating the training data and test data of the dynamic parallel compensator are as follows:

S1. assuming N of M batches of collected aero-engine full flight envelope operation test data are the test data of the condition without performance deterioration, and each batch of test data contains P samples, wherein M, N and P are natural numbers, and M>N; and in each sample, the input variables are sampling time Tₛ, flight altitude H, Mach number Ma and fuel flow W_{f}, and the output variables are compressor delivery pressure P₃, low pressure turbine exit temperature T₅, low pressure rotor speed N₁ and high pressure rotor speed N₂;

S2. producing original nonlinear component-level model output: successively inputting the input variables tᵢ, Hᵢ, Maᵢ and W_{fi} in the N batches of collected test data of the condition without performance deterioration as the input signals into the aero-engine original component-level model, thus obtaining N batches of original nonlinear component-level model output: compressor delivery pressure P₃ᵢ′, low pressure turbine exit temperature T₅ᵢ′, low pressure rotor speed N₁ᵢ′ and high pressure rotor speed N₂ᵢ′, wherein i=1, 2, . . . , N;

S3. producing output data samples: respectively subtracting the test output data of the condition without performance deterioration and the original nonlinear component-level model output, thus obtaining N batches of output data samples, i.e., ΔP₃ᵢ=P₃ᵢ−P₃ᵢ′, ΔT₅ᵢ=T₅ᵢ−T₅ᵢ′, ΔN₁ᵢ=N₁ᵢ−N₁ᵢ′ and ΔN₂ᵢ=N₂ᵢ−N₂ᵢ′, wherein i=1, 2, . . . , N;

S4. conducting normalization processing: successively conducting normalization processing on W_{f}, ΔP₃ᵢ, ΔT₅ᵢ, ΔN₁ᵢ and ΔN₂ᵢ respectively, wherein W*_{fi}=W_{fi}/[Max(W_{fi})−Min(W_{fi})], i=1 . . . N, W*_{fi} is the i^{th} batch of normalized fuel flow, Max(⋅) indicates maximization, and Min(⋅) indicates minimization; and conducting the same normalization processing on N batches of output data samples ΔP₃ᵢ, ΔT₅ᵢ, ΔN₁ᵢ and ΔN₂ᵢ, thus respectively obtaining the i^{th} batch of normalized output data samples, including compressor delivery pressure P*₃ᵢ, low pressure turbine exit temperature T*₅ᵢ, low pressure rotor speed N*₁ᵢ and high pressure rotor speed N*₂ᵢ;

S5. conducting data coding: assuming N batches of test data of the condition without performance deterioration correspond to l flight altitudes and k Mach numbers, and coding the flight altitudes and the Mach numbers, i.e., establishing an l×k-bit binary number, wherein each bit corresponds to the combination of one flight altitude and one Mach number; if one bit of the binary number is 1, the aero-engine operates at the flight altitude and the Mach number;

S6. producing data samples: adding the binary number of the coded flight altitudes and Mach numbers corresponding to the i^{th} batch of test data of the condition without performance deterioration to W*_{fi}, P*₃ᵢ, T*₅ᵢ, N*₁ᵢ and N*₂ᵢ bit by bit, wherein the data length becomes P+l×k, and i=1, 2, . . . , N;

S7. randomly selecting four fifths of N×(P+l×k) samples as training samples and one fifth as test samples.

The steps of building a dynamic parallel compensator based on a recursive neural network algorithm are as follows:

S1. establishing a recursive neural network, wherein the network parameters are: 1 input layer, 1 output layer, 10 RNN recursive neural layers, 6 linear layers and 5 activation layers, the ReLu function is selected as the activation function, the update rule is stochastic gradient descent, the momentum is 0.9, the number of iterations is 20000, the learning rate is set to 10⁻³>lᵣ>10⁻⁵, the weight decay coefficient is set to 0.3>λ>10⁻⁵, and the loss function R adopts the following form:

$$R = \frac{1}{N \times ( P + l \times k )} {( {y}_{t} - {y}_{n} )}^{T} ( {y}_{t} - {y}_{n} ) + \frac{1}{2} λ {w}^{T} w$$

where, yₜ indicates the output data in the test samples, yₙ indicates the output data of the parallel compensator, w indicates the weight in the recursive neural network, and the training samples are adopted for training the recursive neural network;

S2. testing the trained recursive neural network with the test samples, and calculating the loss function;

S3. if the value of the loss function of the test samples is greater than the index ζ, and 0.03≥ζ>0, returning to S1, changing the learning rate lᵣ and the weight decay coefficient λ, and retraining the network; otherwise, saving the network parameters, thus completing the building of the dynamic parallel compensator based on a recursive neural network algorithm.

The steps of a multi-attribute decision algorithm based on integrated evaluation are as follows:

The aero-engine health parameters comprise fan mass flow factor Q_{f}, fan efficient factor E_{f}, compressor flow factor Q_{c}, compressor efficient factor E_{c}, high pressure turbine mass flow factor Qₜₕ, high pressure turbine efficient factor Eₜₕ, low pressure turbine mass flow factor Qₜₗ, low pressure turbine efficient factor Eₜₗ, burner total pressure recovery coefficient SigComb and outer bypass total pressure recovery coefficient SigBypass; and the correction coefficients of the health parameters and the allowed modification range thereof are respectively Fᵢ and [Fᵢₘᵢₙ, Fᵢₘₐₓ], wherein i=1, . . . , 10;

S1. in the original nonlinear component-level model, letting H=0 and Ma=0, respectively giving the fuel flow from ground idling to maximum condition according to the full flight envelope test data, setting all the correction coefficients of the health parameters to 1, and calculating the data Pₐₛ, T₅ₛ, Nᵢₛ and N₂ₛ of each steady state point of the original nonlinear model by simulation;

S2. in the original nonlinear component-level model, letting H=0 and Ma=0, respectively giving the fuel flow from ground idling to maximum condition according to the full flight envelope test data, successively increasing the correction coefficients of the health parameters from Fᵢₘᵢₙ to Fᵢₘₐₓ by a step size of 0.05, keeping the modification values of the remaining health parameters at 1, and calculating the perturbation data P₃ₛᵢⱼ, T₅ₛᵢⱼ, N₁ₛᵢⱼ and N₂ₛᵢⱼ of each steady state point of the original nonlinear model by simulation, wherein i=1, . . . , 10 and j=1, . . . , [(Fᵢₘₐₓ−Fᵢₘᵢₙ)/0.05];

S3. calculating the relative deviations DP₃ₛᵢⱼ=|P₃ₛᵢⱼ−P₃ₛ|/P₃ₛ, DT₅ₛᵢⱼ=|T₅ₛᵢⱼ−T₅ₛ|/T₅ₛ, DN₁ₛᵢⱼ=|N₁ₛᵢⱼ−N₁ₛ|/N₁ₛ and DN₂ₛᵢⱼ=|N₂ₛᵢⱼ−N₂ₛ|/N₂ₛ of errors of the steady state points, wherein i=1, . . . , 10 and j=1, . . . , [(Fᵢₘₐₓ−Fᵢₘᵢₙ)/0.05];

S4. building the decision matrices U=[Uₘ] and Uₘ=[uₗᵢₙ,uᵤᵢₙ] with intervals, wherein

$${u}_{li 1} = {Min}_{j} ( {DP}_{3 sij} ) , {u}_{ui 1} = {Max}_{j} ( {DP}_{3 sij} ) , \\ {u}_{li 2} = {Min}_{j} ( {DT}_{5 sij} ) , {u}_{ui 2} = {Max}_{j} ( {DT}_{5 sij} ) , \\ {u}_{li 3} = {Min}_{j} ( {DP}_{1 sij} ) , {u}_{ui 3} = {Max}_{j} ( {DP}_{1 sij} ) , \\ {u}_{li 4} = {Min}_{j} ( {DP}_{2 sij} ) , {u}_{ui 4} = {Max}_{j} ( {DN}_{2 sij} ) ,$$

and n=1, . . . , 4;

S5. calculating

$${B}_{in} = [ {b}_{in} ] = \frac{k ( {U}_{in} )}{{\sum }_{i = 1}^{10} k ( {U}_{in} )} , k ( {U}_{in} ) = ( {u}_{lin} + {u}_{uin} ) / 2$$

$${E}_{in} = [ {e}_{in} ] = \frac{1 - L ( {U}_{in} )}{10 - {\sum }_{i = 1}^{10} L ( {U}_{in} )} , L ( {U}_{in} ) = {u}_{uin} - {u}_{lin}$$

$${q}_{n} = η ( - \frac{1}{ln 10} {\sum }_{i = 1}^{10} {b}_{in} ln {b}_{in} ) + ( 1 - η ) ( - \frac{1}{ln 10} {\sum }_{i = 1}^{10} {e}_{in} ln {e}_{in} )$$

where, Bᵢₙ is a midpoint normalization matrix, Eᵢₙ is a length normalization matrix, qₙ is the information entropy of the n^{th} attribute, 0<η<1 is the balance factor, i=1, . . . , 10 and n=1, . . . , 4;
calculating the entropy weight

$${w}_{n} = \frac{1 - {q}_{n}}{{\sum }_{n = 1}^{4} ( 1 - {q}_{n} )} ;$$

S6. calculating the entropy weight decision value

vᵢ=1−Σₙ₌₁⁴wₙ(|uₗᵢₙ−u*ᵢₙ|+|uᵤᵢₙ−u*ᵢₙ|)/2

where, u*ᵢₙ=(uₗᵢₙ+uᵤᵢₙ)/2, i=1, . . . , 10 and n=1, . . . , 4;

S3.7 constructing a weighted standardization decision matrix Jᵢₙ=Uᵢₙwₙ, and determining the sizes of a positive ideal solution \tilde{c}⁺ and a negative ideal solution \tilde{c}⁻ respectively as

$$\{ \begin{matrix}{\tilde{c}}^{+} = ( {\tilde{c}}_{1}^{+} , … , {\tilde{c}}_{4}^{+} ) \\ {\tilde{c}}^{-} = ( {\tilde{c}}_{1}^{-} , … , {\tilde{c}}_{4}^{-} )\end{matrix} \\ where , \\ {\tilde{c}}_{n}^{+} = {Max}_{i} ( {J}_{in} ) and {c}_{n}^{-} = {Min}_{i} ( {J}_{in} ) ;$$

calculating the distance

$$\{ \begin{matrix}{d}_{i}^{+} = \sqrt{{\sum }_{n = 1}^{4} {( {J}_{in} - {\tilde{c}}_{n}^{+} )}^{2}} \\ {d}_{i}^{-} = \sqrt{{\sum }_{n = 1}^{4} {( {J}_{in} - {\tilde{c}}_{n}^{+} )}^{2}}\end{matrix}$$

where, d⁺ᵢ is the distance between the weighted standardization decision matrix Jᵢₙ and the positive ideal solution \tilde{c}⁺, and the d⁻ᵢ is the distance between the weighted standardization decision matrix Jᵢₙ and the negative ideal solution \tilde{c}⁻;
calculating the decision value

$${c}_{i} = \frac{{d}_{i}^{-}}{{d}_{i}^{-} + {d}_{i}^{+}} ,$$

wherein i=1, . . . , 10;

S8. calculating the integrated decision value Fᵢ=α(vᵢ+cᵢ), wherein α is the amplification coefficient and is 1, and i=1, . . . , 10, sequencing the integrated decision values from large to small, and selecting the first four parameters as the health parameters to be modified.

The parameters of the modifier based on a genetic algorithm are set as follows: the population size of the genetic algorithm is 100, the number of iterations is 20, the number of good generations is 5, the probability of mutation is generated by Gaussian distribution, the probability of crossover is 0.8, the fitness function of the genetic algorithm is the sum of the aero-engine full flight envelope operation test data of P₃, T₅, N₁ and N₂ and the error of the aero-engine nonlinear component-level model output modified by the modifier, and the number of variables is 4.

The present invention has the following beneficial effect that: the method provided by the present invention has higher precision than the existing modification method when modifying the aero-engine nonlinear component-level model, thereby realizing the precise description of the model on the test data within the full flight envelope. The aero-engine nonlinear model can be directly used for design and verification of the control system and fault diagnosis system. Therefore, improving the steady state and transient state model precision of the nonlinear model can indirectly enhance the design and parameter testing effect of the engine control system on one hand; and can directly improve the verification precision and reliability of the aero-engine digital simulation platform, hardware-in-loop simulation platform and semi-physical simulation platform on the other hand, thereby providing direct and beneficial effects for the actual verification link of engineering. Meanwhile, the method can be extended to the modeling and modification of other types of turbine engines and marine gas turbine engines through appropriate adjustment, and has wider universality.

### DESCRIPTION OF DRAWINGS

FIG. 1 is a schematic diagram of a system structure of an aero-engine full flight envelope model adaptive modification method based on a deep learning algorithm;

FIG. 2 is a flow diagram of an algorithm of an aero-engine full flight envelope model adaptive modification method based on a deep learning algorithm;

FIG. 3 is a flow diagram of a generating algorithm for the training data and test data of a dynamic parallel compensator;

FIG. 4 is a flow diagram of a multi-attribute decision algorithm based on integrated evaluation;

FIG. 5 is a comparison diagram of P₃ data of original nonlinear component-level model output and test data under a condition;

FIG. 6 is a comparison diagram of T₅ data of original nonlinear component-level model output and test data under a condition;

FIG. 7 is an effect diagram of aero-engine full flight envelope model adaptive modification P₃ based on a deep learning algorithm;

FIG. 8 is an effect diagram of aero-engine full flight envelope model adaptive modification T₅ based on a deep learning algorithm.

### DETAILED DESCRIPTION

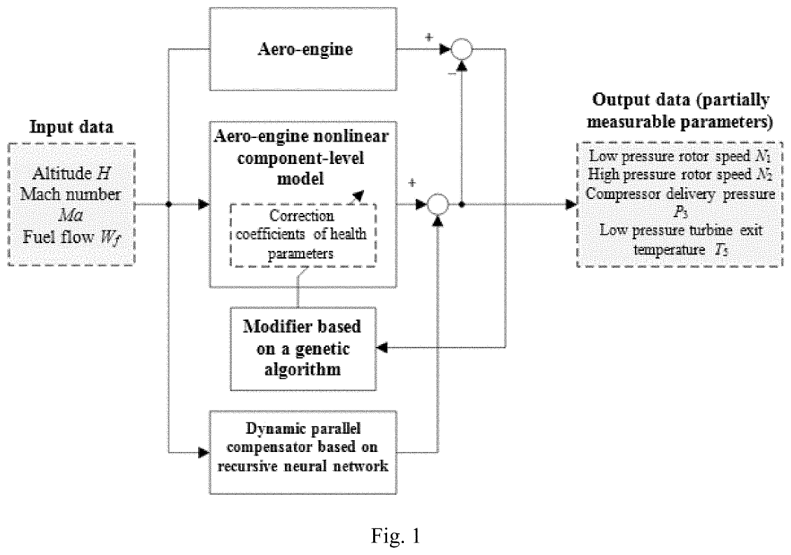

The present invention is further described below in combination with the drawings. The present invention replies on the background of a nonlinear mathematical model and test data of a certain type of low bypass ratio turbofan engine, and the system structure diagram is shown in FIG. 1.

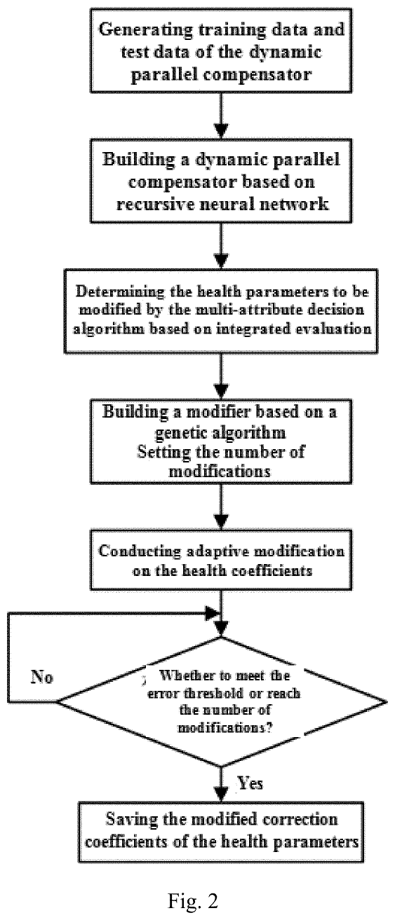

As shown in FIG. 2, an aero-engine full flight envelope model adaptive modification method based on a deep learning algorithm, comprising the following steps:

S1. generating training data and test data for establishing a dynamic parallel compensator based on a recursive neural network algorithm according to the collected test data of the condition without performance deterioration in the aero-engine full flight envelope operation test data;

S2. building a dynamic parallel compensator based on a recursive neural network algorithm by using the generated training data and test data of the dynamic parallel compensator;

S3. determining health parameters to be modified in the aero-engine original nonlinear component-level model by a multi-attribute decision algorithm based on integrated evaluation;

S4. building a modifier based on a genetic algorithm, and setting the number of modifications to 20≥Q>0, wherein Q is set to 10 in the embodiment;

S5. conducting adaptive modification on the correction coefficients of the health parameters to be modified in the original nonlinear component-level model;

S6. calculating the sum of the modified nonlinear component-level model output and the dynamic parallel compensator output under a given input signal, and then subtracting the corresponding output data in the aero-engine full flight envelope operation test data under the given condition; if the difference e is not greater than the error threshold ε=0.04 (0.05≥ε>0) or the number of modifications Q is reached, entering S7; otherwise, returning to S5;

S7. saving the modified correction coefficients of the health parameters to be modified.

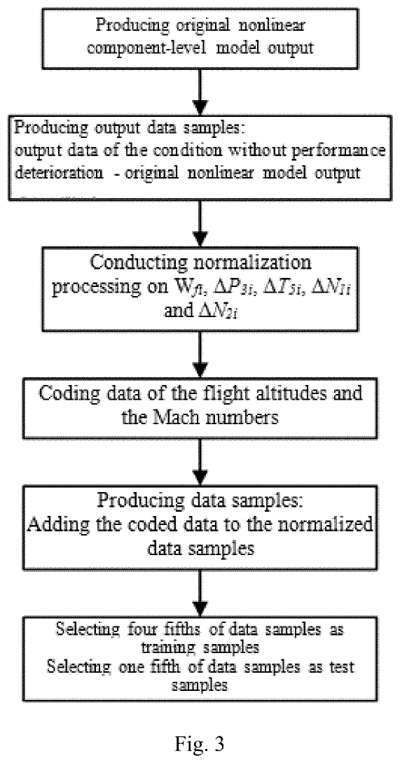

As shown in FIG. 3, the steps of generating the training data and test data of the dynamic parallel compensator are as follows:

S1. assuming N=150 of M=980 batches of collected aero-engine full flight envelope operation test data are the test data of the condition without performance deterioration, and each batch of test data contains P=1000 samples. In each sample, the input variables are sampling time Tₛ=0.025, flight altitude H, Mach number Ma and fuel flow W_{f}, and the output variables are compressor delivery pressure P₃, low pressure turbine exit temperature T₅, low pressure rotor speed N₁ and high pressure rotor speed N₂;

S2. producing original nonlinear component-level model output: successively inputting the input variables tᵢ, Hᵢ, Maᵢ and W_{fi} in the N batches of collected test data of the condition without performance deterioration as the input signals into the aero-engine original component-level model, thus obtaining N batches of original nonlinear component-level model output (compressor delivery pressure P₃ᵢ′, low pressure turbine exit temperature T₅ᵢ′, low pressure rotor speed N₁ᵢ′ and high pressure rotor speed N₂ᵢ′), wherein i=1, 2, . . . , N;

S3. producing output data samples: respectively subtracting the test output data of the condition without performance deterioration and the original model output, thus obtaining N batches of output data samples, i.e., ΔP₃ᵢ=P₃ᵢ−P₃ᵢ′, ΔT₅ᵢ=T₅ᵢ−T₅ᵢ′, ΔN₁ᵢ=N₁ᵢ−N₁ᵢ′ and ΔN₂ᵢ=N₂ᵢ−N₂ᵢ′, wherein i=1, 2, . . . , N;

S4. conducting normalization processing: successively conducting normalization processing on W_{fi}, ΔP₃ᵢ, ΔT₅ᵢ, ΔN₁ᵢ and ΔN₂ᵢ respectively, for example, W*_{fi}=W_{fi}/[Max(W_{fi})−Min(W_{fi})], i=1 . . . N, W*_{fi} is the i^{th} batch of normalized fuel flow, Max(⋅) indicates maximization, and Min(⋅) indicates minimization; and conducting the same normalization processing on N batches of output data samples ΔP₃ᵢ, ΔT₅ᵢ, ΔN₁ᵢ and ΔN₂ᵢ, thus respectively obtaining the i^{th} batch of normalized output data samples, including compressor delivery pressure P*₃ᵢ, low pressure turbine exit temperature T*₅ᵢ, low pressure rotor speed N*₁ᵢ and high pressure rotor speed N*₂ᵢ;

S5. conducting data coding: assuming N batches of test data of the condition without performance deterioration correspond to l=3 flight altitudes and k=3 Mach numbers, and coding the flight altitudes and the Mach numbers, i.e., establishing a 9-bit binary number, wherein each bit corresponds to the combination of one flight altitude and one Mach number;

S6. producing data samples: adding the binary number of the coded flight altitudes and Mach numbers corresponding to the i^{th} batch of test data of the condition without performance deterioration to W*_{fi}, P*₃ᵢ, T*₅ᵢ, N*₁ᵢ and N*₂ᵢ bit by bit, wherein the data length becomes 1009, and i=1, 2, . . . , N;

S7. randomly selecting 120×1009 samples as training samples and 30×1009 samples as test samples.

The steps of building a dynamic parallel compensator based on a recursive neural network algorithm are as follows:

S1. establishing a recursive neural network, wherein the network parameters are: 1 input layer, 1 output layer, 10 RNN (recursive neural layers), 6 linear layers and 5 activation layers, the ReLu function is selected as the activation function, the update rule is stochastic gradient descent, the momentum is 0.9, the number of iterations is 20000, the learning rate is set to lᵣ=10⁻⁴, the weight decay coefficient is set to λ=10⁻³, and the loss function R adopts the following form:

$$R = \frac{1}{N \times ( P + l \times k )} {( {y}_{t} - {y}_{n} )}^{T} ( {y}_{t} - {y}_{n} ) + \frac{1}{2} λ {w}^{T} w$$

where, yₜ indicates the output data in the test samples, yₙ indicates the output data of the parallel compensator, w indicates the weight in the recursive neural network, and the training samples are adopted for training the recursive neural network;

S2. testing the trained recursive neural network with the test samples, and calculating the loss function;

S3. if the value of the loss function of the test samples is greater than the index ζ=0.02, returning to S1, changing the learning rate lᵣ, and the weight decay coefficient λ, and retraining the network; otherwise, saving the network parameters, thus completing the building of the dynamic parallel compensator based on a recursive neural network algorithm.

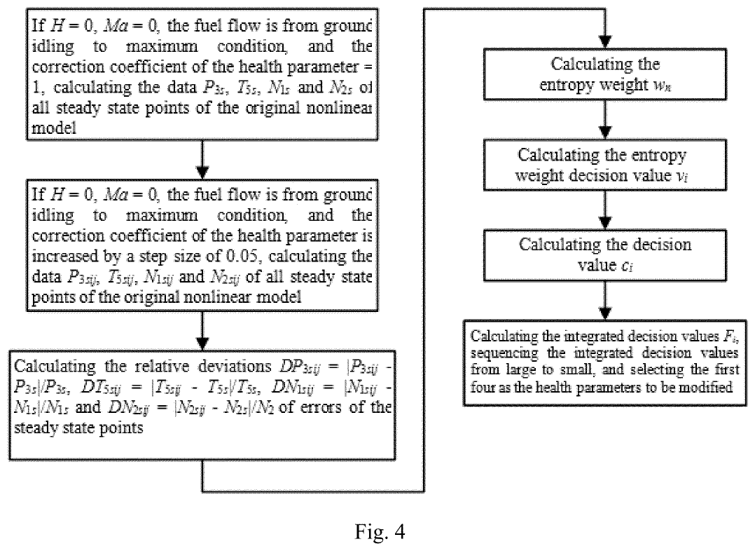

As shown in FIG. 4, the steps of a multi-attribute decision algorithm based on integrated evaluation are as follows:

The aero-engine health parameters comprise fan mass flow factor Q_{f}, fan efficient factor E_{f}, compressor flow factor Q_{c}, compressor efficient factor E_{c}, high pressure turbine mass flow factor Qₜₕ, high pressure turbine efficient factor Eₜₕ, low pressure turbine mass flow factor Qₜₗ, low pressure turbine efficient factor Eₜₗ, burner total pressure recovery coefficient SigComb and outer bypass total pressure recovery coefficient SigBypass; and the correction coefficients of the health parameters and the allowed modification range thereof are respectively Fᵢ and [Fᵢₘᵢₙ, Fᵢₘₐₓ,], wherein i=1, . . . , 10, and the requirements of the provided modification range are shown in Table 1;

TABLE 1
Modification Range of Correction Coefficients of Health Parameters

| Parameter | Q_{f} | E_{f} | Q_{c} | E_{c} | Qₜₕ | Eₜₕ | Qₜₗ | Eₜₗ | SigComb | SigBypass |
|---|---|---|---|---|---|---|---|---|---|---|
| Fᵢₘᵢₙ | 0.7 | 0.75 | 0.7 | 0.7 | 0.75 | 0.7 | 0.7 | 0.7 | 0.8 | 0.7 |
| Fᵢₘₐₓ | 1.05 | 1.1 | 1.05 | 1.1 | 1.1 | 1.1 | 1.1 | 1.1 | 1.1 | 1.1 |

S1. in the original nonlinear component-level model, letting H=0 and Ma=0, respectively giving the fuel flow from ground idling to maximum condition according to the full flight envelope test data, setting all the correction coefficients of the health parameters to 1, and calculating the data P₃ₛ, T₅ₛ, N₁ₛ and N₂ₛ of each steady state point of the original nonlinear model by simulation;

S2. in the original nonlinear component-level model, letting H=0 and Ma=0, respectively giving the fuel flow from ground idling to maximum condition according to the full flight envelope test data, successively increasing the correction coefficients of the health parameters from Fᵢₘᵢₙ, to Fᵢₘₐₓ by a step size of 0.05, keeping the modification values of the remaining health parameters at 1, and calculating the perturbation data P₃ₛᵢⱼ, T₅ₛᵢⱼ, N₁ₛᵢⱼ and N₂ₛᵢⱼ of each steady state point of the original nonlinear model by simulation, wherein i=1, . . . , 10 and j=1, . . . , [Fᵢₘₐₓ−Fᵢₘᵢₙ)/0.05];

S3. calculating the relative deviations DP₃ₛᵢⱼ=|P₃ₛᵢⱼ−P₃ₛ|/P₃ₛ, DT₅ₛᵢⱼ=|T₅ₛᵢⱼ−T₅ₛ|/T₅ₛ, DN₁ₛᵢⱼ=|N₁ₛᵢⱼ−N₁ₛ|/N₁ₛ and DN_{2sy}=|N₂ₛᵢⱼ−N₂ₛ|/N₂ₛ of errors of the steady state points, wherein i=1, . . . , 10 and j=1, . . . , [(Fᵢₘₐₓ−Fᵢₘᵢₙ)/0.05];

S4. building the decision matrices U=[Uᵢₙ] and uᵢₙ=[uₗᵢₙ,uᵤᵢₙ] with intervals, wherein

$${u}_{li 1} = {Min}_{j} ( {DP}_{3 sij} ) , {u}_{ui 1} = {Max}_{j} ( {DP}_{3 sij} ) , {u}_{li 2} = {Min}_{j} ( {DT}_{5 sij} ) , \\ {u}_{ui 2} = {Max}_{j} ( {DT}_{5 sij} ) , {u}_{li 3} = {Min}_{j} ( {DN}_{1 sij} ) , {u}_{ui 3} = {Max}_{j} ( {DN}_{1 sij} ) , \\ {u}_{li 4} = {Min}_{j} ( {DN}_{2 sij} ) , {u}_{ui 4} = {Max}_{j} ( {DN}_{2 sij} ) ,$$

i=1, . . . , 10 and n=1, . . . , 4;

S5. calculating

$${B}_{i n} = [ {b}_{i n} ] = \frac{k ( {U}_{i n} )}{{\sum }_{i = 1}^{10} k ( {U}_{i n} )} , k ( {U}_{i n} ) = ( {u}_{lin} + {u}_{uin} ) / 2$$

$${E}_{i n} = [ {e}_{i n} ] = \frac{1 - L ( {U}_{i n} )}{10 - {\sum }_{i = 1}^{10} L ( {U}_{i n} )} , L ( {U}_{i n} ) = {u}_{uin} - {u}_{lin}$$

$${q}_{n} = η ( - \frac{1}{ln 10} {\sum }_{i = 1}^{10} {b}_{i n} ln {b}_{i n} ) + ( 1 - η ) ( - \frac{1}{ln 10} {\sum }_{i = 1}^{10} {e}_{i n} ln {e}_{i n} )$$

where, the balance factor η=0.5, i=1, . . . , 10 and n=1, . . . , 4;
calculating the entropy weight

$${w}_{n} = \frac{1 - {q}_{n}}{{\sum }_{n = 1}^{4} ( 1 - {q}_{n} )} ;$$

S6. calculating the entropy weight decision value

vᵢ=1−Σₙ₌₁⁴wₙ(|uₗᵢₙ−u*ᵢₙ|+|uᵤᵢₙ−u*ᵢₙ|)/2

where, u*ᵢₙ=(uₗᵢₙ+uᵤᵢₙ)/2, i=1, . . . , 10 and n=1, . . . , 4, it is the entropy weight decision value in the embodiment;

S7. constructing a weighted standardization decision matrix Jᵢₙ=Uᵢₙwₙ, and determining the sizes of a positive ideal solution \tilde{c}⁺ and a negative ideal solution \tilde{c}⁻ respectively as

$$\{ \begin{matrix}{\tilde{c}}^{+} = ( {\tilde{c}}_{1}^{+} , … , {\tilde{c}}_{4}^{+} ) \\ {\tilde{c}}^{-} = ( {\tilde{c}}_{1}^{-} , … , {\tilde{c}}_{4}^{-} )\end{matrix} \\ where , {\tilde{c}}_{n}^{+} = {Max}_{i} ( {J}_{i n} ) and {\tilde{c}}_{n}^{-} = {Min}_{i} ( {J}_{i n} ) ;$$

calculating the distance

$$\{ \begin{matrix}{d}_{i}^{+} = \sqrt{{\sum }_{n = 1}^{4} {( {J}_{i n} - {\tilde{c}}_{n}^{+} )}^{2}} \\ {d}_{i}^{-} = \sqrt{{\sum }_{n = 1}^{4} {( {J}_{i n} - {\tilde{c}}_{n}^{-} )}^{2}}\end{matrix} ;$$

calculating the decision value

$${c}_{i} = \frac{{d}_{i}^{-}}{{d}_{i}^{-} + {d}_{i}^{+}} ,$$

wherein i=1, . . . , 10;

S8. calculating the integrated decision values Fᵢ=α(vᵢ+cᵢ), wherein i=1, . . . , 10, sequencing the integrated decision values from large to small, and selecting the first four parameters as the health parameters to be modified. The parameters selected in the embodiment are Eₜₗ, Qₜₗ, E_{f} and Q_{f}.

The parameters of the modifier based on a genetic algorithm are set as follows: the population size of the genetic algorithm is 100, the number of iterations is 20, the number of good generations is 5, the probability of mutation is generated by Gaussian distribution, the probability of crossover is 0.8, the fitness function of the genetic algorithm is the sum of the aero-engine full flight envelope operation test data of P₃, T₅, N₁ and N₂ and the error of the aero-engine nonlinear component-level model output modified by the modifier, and the number of variables is 4. The modification results of the correction coefficients of the health parameters are as follows:

Eₜₗ=0.8879628078986851; Qₜₗ=0.9981193434041549;

E_{f}=0.9557873575305739; Q_{f}=0.9897485939854536.

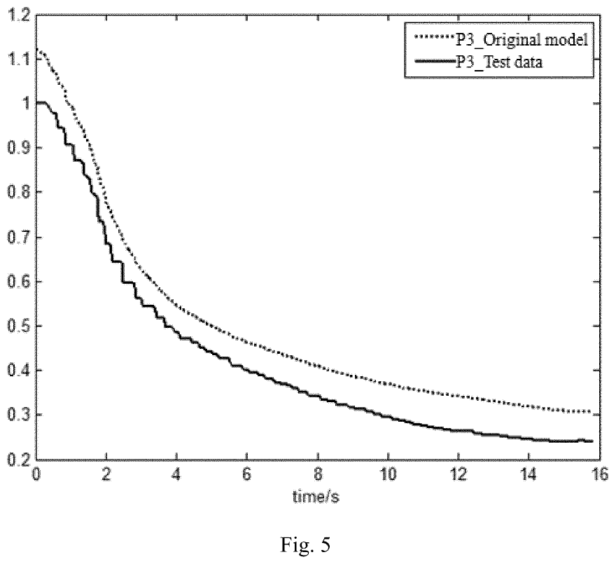

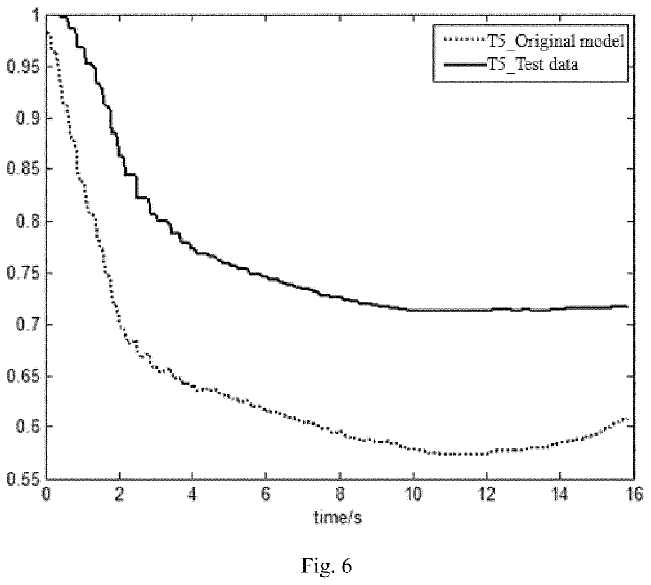

The difference between the original model before modification and the test data is shown in FIG. 5 and FIG. 6 which are respectively the comparison diagrams of P₃ data and T₅ data of the original nonlinear component-level model output and the test data under a condition. The average relative errors of P₃ and T₅ of original modeling are 20.27% and 17.30%.

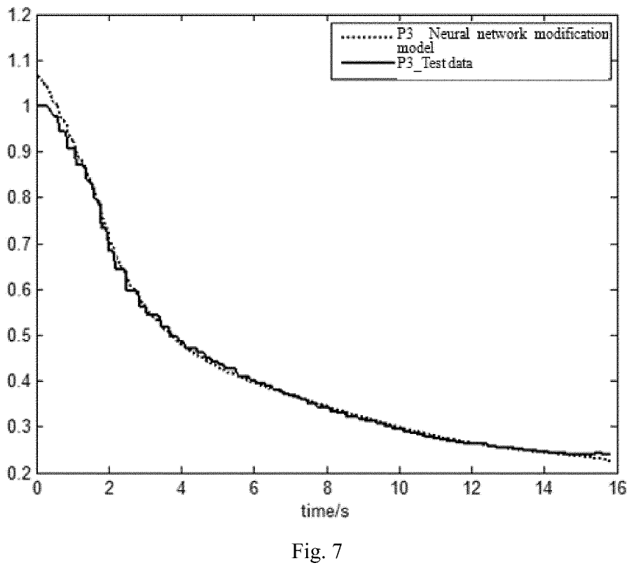

FIG. 7 is a comparison diagram of P₃ of the model output modified by the aero-engine full flight envelope model adaptive modification method based on a deep learning algorithm provided by the present invention and the test data, and the average relative error of modeling is 1.42%.

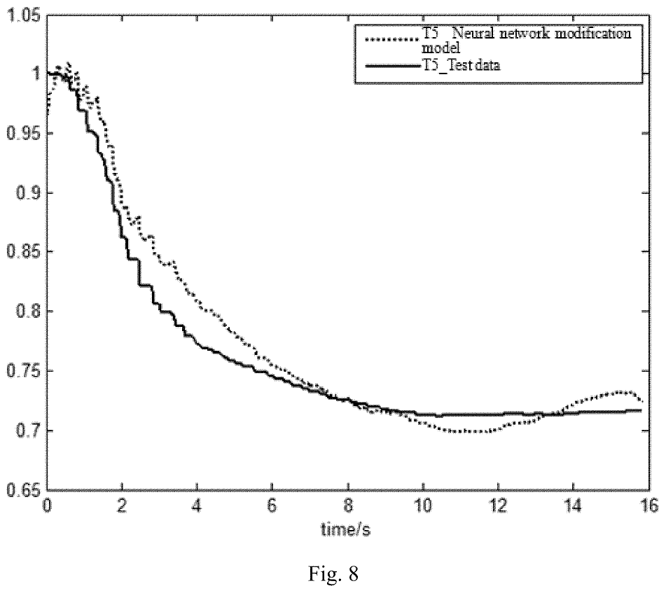

FIG. 8 is a comparison diagram of T₅ of the model output modified by the aero-engine full flight envelope model adaptive modification method based on a deep learning algorithm provided by the present invention and the test data, and the average relative error of modeling is 1.91%.

In conclusion, the steady state performance and the transient state performance can be obviously improved after modification by the aero-engine full flight envelope model adaptive modification method based on a deep learning algorithm.

1. An aero-engine full flight envelope model adaptive modification method based on a deep learning algorithm, comprising the following steps:
S1. generating training data and test data for establishing a dynamic parallel compensator based on a recursive neural network algorithm according to the collected test data of the condition without performance deterioration in the aero-engine full flight envelope operation test data;
S2. building a dynamic parallel compensator based on a recursive neural network algorithm by using the generated training data and test data of the dynamic parallel compensator;
S3. determining health parameters to be modified in the aero-engine original nonlinear component-level model by a multi-attribute decision algorithm based on integrated evaluation according to the test data of the deterioration condition of the aero-engine full flight envelope;
S4. building a modifier based on a genetic algorithm, and setting the number of modifications to 20≥Q>0;
S5. conducting adaptive modification on the correction coefficients of the health parameters to be modified in the original nonlinear component-level model;
S6. calculating the sum of the modified nonlinear component-level model output and the dynamic parallel compensator output under a given input signal, and then subtracting the corresponding output data in the aero-engine full flight envelope operation test data under the given condition; if the difference e is not greater than the error threshold ε, 0.05≥ε>0 or the number of modifications Q is reached, entering S7; otherwise, returning to S5;
S7. saving the modified correction coefficients of the health parameters to be modified.

2. The aero-engine full flight envelope model adaptive modification method based on a deep learning algorithm according to claim 1, wherein the steps of generating the training data and test data of the dynamic parallel compensator are as follows:
S1.1 assuming N of M batches of collected aero-engine full flight envelope operation test data are the test data of the condition without performance deterioration, and each batch of test data contains P samples, wherein M, N and P are natural numbers, and M>N; and in each sample, the input variables are sampling time Tₛ, flight altitude H, Mach number Ma and fuel flow W_{f}, and the output variables are compressor delivery pressure P₃, low pressure turbine exit temperature T₅, low pressure rotor speed N₁ and high pressure rotor speed N₂;
S1.2 producing original nonlinear component-level model output: successively inputting the input variables tᵢ, Hᵢ, Maᵢ and W_{fi} in the N batches of collected test data of the condition without performance deterioration as the input signals into the aero-engine original component-level model, thus obtaining N batches of original nonlinear component-level model output: compressor delivery pressure P₃ᵢ′, low pressure turbine exit temperature T₅ᵢ′, low pressure rotor speed N₁ᵢ′ and high pressure rotor speed N₂ᵢ′, wherein i=1, 2, . . . , N;
S1.3 producing output data samples: respectively subtracting the test output data of the condition without performance deterioration and the original nonlinear component-level model output, thus obtaining N batches of output data samples, i.e., ΔP₃ᵢ=P₃ᵢ−P₃ᵢ′, ΔT₅ᵢ=T₅ᵢ−T₅ᵢ′, ΔN₁ᵢ=N₁ᵢ−N₁ᵢ′ and ΔN₂ᵢ=N₂ᵢ−N₂ᵢ′, wherein i=1, 2, . . . , N;
S1.4 conducting normalization processing: successively conducting normalization processing on W_{fi}, ΔP₃ᵢ, ΔT₅ᵢ, ΔN₁ᵢ and ΔN₂ᵢ respectively, wherein W*_{fi}=W_{fi}/[Max(W_{fi})−Min(W_{fi})], i=1 . . . N, W*_{fi} is the i^{th} batch of normalized fuel flow, Max(⋅) indicates maximization, and Min(⋅) indicates minimization; and conducting the same normalization processing on N batches of output data samples ΔP₃ᵢ, ΔT₅ᵢ, ΔN₁ᵢ and ΔN₂ᵢ, thus respectively obtaining the i^{th} batch of normalized output data samples, including compressor delivery pressure P*₃ᵢ, low pressure turbine exit temperature T*₅ᵢ, low pressure rotor speed N*₁ᵢ and high pressure rotor speed N*₂ᵢ;
S1.5 coding data: assuming N batches of test data of the condition without performance deterioration correspond to l flight altitudes and k Mach numbers, and coding the flight altitudes and the Mach numbers, i.e., establishing an l×k-bit binary number, wherein each bit corresponds to the combination of one flight altitude and one Mach number; if one bit of the binary number is 1, the aero-engine operates at the flight altitude and the Mach number;
S1.6 producing data samples: adding the binary number of the coded flight altitudes and Mach numbers corresponding to the i^{th} batch of test data of the condition without performance deterioration to W*_{fi}, P*₃ᵢ, T*₅ᵢ, N*₁ᵢ and N*₂ᵢ bit by bit, wherein the data length becomes P+l×k, and i=1, 2, . . . , N;
S1.7 randomly selecting four fifths of N×(P+l×k) samples as training samples and one fifth as test samples.

3. The aero-engine full flight envelope model adaptive modification method based on a deep learning algorithm according to claim 2, wherein the steps of building a dynamic parallel compensator based on a recursive neural network algorithm are as follows:
S2.1 establishing a recursive neural network, wherein the network parameters are: 1 input layer, 1 output layer, 10 RNN recursive neural layers, 6 linear layers and 5 activation layers, the ReLu function is selected as the activation function, the update rule is stochastic gradient descent, the momentum is 0.9, the number of iterations is 20000, the learning rate is set to 10⁻³>lᵣ>10⁻⁵, the weight decay coefficient is set to 0.3>λ>10⁻⁵, and the loss function R adopts the following form:
$$R = \frac{1}{N \times ( P + l \times k )} {( {y}_{t} - {y}_{n} )}^{T} ( {y}_{t} - {y}_{n} ) + \frac{1}{2} λ {w}^{T} w$$
where, yₜ indicates the output data in the test samples, yₙ indicates the output data of the parallel compensator, w indicates the weight in the recursive neural network, and the training samples are adopted for training the recursive neural network;
S2.2 testing the trained recursive neural network with the test samples, and calculating the loss function;
S2.3 if the value of the loss function of the test samples is greater than the index ζ, and 0.03≥ζ>0, returning to S2.1, changing the learning rate lᵣ and the weight decay coefficient λ, and retraining the network; otherwise, saving the network parameters, thus completing the building of the dynamic parallel compensator based on a recursive neural network algorithm.

4. The aero-engine full flight envelope model adaptive modification method based on a deep learning algorithm according to claim 3, wherein the steps of a multi-attribute decision algorithm based on integrated evaluation are as follows:
the aero-engine health parameters comprise fan mass flow factor Q_{f}, fan efficient factor E_{f}, compressor flow factor Q_{c}, compressor efficient factor E_{c}, high pressure turbine mass flow factor Qₜₕ, high pressure turbine efficient factor Eₜₕ, low pressure turbine mass flow factor Qₜₗ, low pressure turbine efficient factor Eₜₗ, burner total pressure recovery coefficient SigComb and outer bypass total pressure recovery coefficient SigBypass; the correction coefficients of the health parameters and the allowed modification range thereof are respectively F_{F} and [Fᵢₘᵢₙ, Fᵢₘₐₓ], wherein i=1, . . . , 10;
S3.1 in the original nonlinear component-level model, letting H=0 and Ma=0, respectively giving the fuel flow from ground idling to maximum condition according to the full flight envelope test data, setting all the correction coefficients of the health parameters to 1, and calculating the data P₃ₛ, T₅ₛ, N₁ₛ and N₂ₛ of each steady state point of the original nonlinear model by simulation;
S3.2 in the original nonlinear component-level model, letting H=0 and Ma=0, respectively giving the fuel flow from ground idling to maximum condition according to the full flight envelope test data, successively increasing the correction coefficients of the health parameters from Fᵢₘᵢₙ to Fᵢₘₐₓ by a step size of 0.05, keeping the modification values of the remaining health parameters at 1, and calculating the perturbation data P₃ₛᵢⱼ, T₅ₛᵢⱼ, N₁ₛᵢⱼ and N₂ₛᵢⱼ of each steady state point of the original nonlinear model by simulation, wherein i=1, . . . , 10 and j=1, . . . , [Fᵢₘₐₓ−Fᵢₘᵢₙ)/0.05];
S3.3 calculating the relative deviations DP₃ₛᵢⱼ=|P₃ₛᵢⱼ−P₃ₛ|/P₃ₛ, DT₅ₛᵢⱼ=|T₅ₛᵢⱼ−T₅ₛ|/T₅ₛ, DN₁ₛᵢⱼ=|N₁ₛᵢⱼ−N₁ₛ and DN₂ₛᵢⱼ=|N₂ₛᵢⱼ−N₂ₛ|/N₂ₛ of errors of the steady state points, wherein i=1, . . . , 10 and j=1, . . . , [(Fᵢₘₐₓ−Fᵢₘᵢₙ)/0.05];
S3.4 building the decision matrices U=[Uᵢₙ] and Uᵢₙ=[uₗᵢₙ,uᵤᵢₙ] with intervals, wherein
$${u}_{li 1} = {Min}_{j} ( {DP}_{3 sij} ) , {u}_{ui 1} = {Max}_{j} ( {DP}_{3 sij} ) , {u}_{li 2} = {Min}_{j} ( {DT}_{5 sij} ) , \\ {u}_{ui 2} = {Max}_{j} ( {DT}_{5 sij} ) , {u}_{li 3} = {Min}_{j} ( {DN}_{1 sij} ) , {u}_{ui 3} = {Max}_{j} ( {DN}_{1 sij} ) , \\ {u}_{li 4} = {Min}_{j} ( {DN}_{2 sij} ) , {u}_{ui 4} = {Max}_{j} ( {DN}_{2 sij} ) ,$$
i=1, . . . , 10 and n=1, . . . , 4;
S3.5 calculating
$${B}_{i n} = [ {b}_{i n} ] = \frac{k ( {U}_{i n} )}{{\sum }_{i = 1}^{10} k ( {U}_{i n} )} , k ( {U}_{i n} ) = ( {u}_{lin} + {u}_{uin} ) / 2$$
$${E}_{i n} = [ {e}_{i n} ] = \frac{1 - L ( {U}_{i n} )}{10 - {\sum }_{i = 1}^{10} L ( {U}_{i n} )} , L ( {U}_{i n} ) = {u}_{uin} - {u}_{lin}$$
$${q}_{n} = η ( - \frac{1}{ln 10} {\sum }_{i = 1}^{10} {b}_{i n} ln {b}_{i n} ) + ( 1 - η ) ( - \frac{1}{ln 10} {\sum }_{i = 1}^{10} {e}_{i n} ln {e}_{i n} )$$
where, Bᵢₙ is a midpoint normalization matrix, Eᵢₙ is a length normalization matrix, qₙ is the information entropy of the n^{th} attribute, 0<η<1 is the balance factor, i=1, . . . , 10 and n=1, . . . , 4;
calculating the entropy weight
$${w}_{n} = \frac{1 - {q}_{n}}{{\sum }_{n = 1}^{4} ( 1 - {q}_{n} )} ;$$
S3.6 calculating the entropy weight decision value
vᵢ=1−Σₙ₌₁⁴wₙ(|uₗᵢₙ−u*ᵢₙ|+|uᵤᵢₙ−u*ᵢₙ|)/2
where, u*ᵢₙ=(uₗᵢₙ+uᵤᵢₙ)/2, i=1, . . . , 10 and n=1, . . . , 4;
S3.7 constructing a weighted standardization decision matrix Jᵢₙ=Uᵢₙwₙ, and determining the sizes of a positive ideal solution \tilde{c}⁺ and a negative ideal solution \tilde{c}⁻ respectively as
$$\{ \begin{matrix}{\tilde{c}}^{+} = ( {\tilde{c}}_{1}^{+} , … , {\tilde{c}}_{4}^{+} ) \\ {\tilde{c}}^{-} = ( {\tilde{c}}_{1}^{-} , … , {\tilde{c}}_{4}^{-} )\end{matrix} \\ where , {\tilde{c}}_{n}^{+} = {Max}_{i} ( {J}_{i n} ) and {\tilde{c}}_{n}^{-} = {Min}_{i} ( {J}_{i n} ) ;$$
calculating the distance
$$\{ \begin{matrix}{d}_{i}^{+} = \sqrt{{\sum }_{n = 1}^{4} {( {J}_{i n} - {\tilde{c}}_{n}^{+} )}^{2}} \\ {d}_{i}^{-} = \sqrt{{\sum }_{n = 1}^{4} {( {J}_{i n} - {\tilde{c}}_{n}^{-} )}^{2}}\end{matrix} ;$$
where, d⁺ᵢ is the distance between the weighted standardization decision matrix Jᵢₙ and the positive ideal solution \tilde{c}⁺, and the d⁻ᵢ is the distance between the weighted standardization decision matrix Jᵢₙ and the negative ideal solution \tilde{c}⁻;
calculating the decision value
$${c}_{i} = \frac{{d}_{i}^{-}}{{d}_{i}^{-} + {d}_{i}^{+}} ,$$
wherein i=1, . . . , 10;
S3.8 calculating the integrated decision value Fᵢ=α(vᵢ+cᵢ), wherein α is the amplification coefficient and is 1, and i=1, . . . , 10, sequencing the integrated decision values from large to small, and selecting the first four parameters as the health parameters to be modified.

5. The aero-engine full flight envelope model adaptive modification method based on a deep learning algorithm according to claim 4, wherein the parameters of the modifier based on a genetic algorithm are set as follows: the population size of the genetic algorithm is 100, the number of iterations is 20, the number of good generations is 5, the probability of mutation is generated by Gaussian distribution, the probability of crossover is 0.8, the fitness function of the genetic algorithm is the sum of the aero-engine full flight envelope operation test data of P₃, T₅, N₁ and N₂ and the error of the aero-engine nonlinear component-level model output modified by the modifier, and the number of variables is 4.
